(19) United States
(12) Patent Application Publication
(10) Pub. No.: US 2019/0261262 A1
(43) Pub. Date: Aug. 22, 2019

(54) HYBRID WIRELESS LINK EMPLOYING FREE-SPACE OPTICAL COMMUNICATION, RADIO FREQUENCY COMMUNICATION, AND INTELLIGENT FRAME AND PACKET SWITCHING

(71) Applicant: Collinear Networks, Inc., Santa Clara, CA (US)

(72) Inventors: William H. Stiles, Fort Worth, TX (US); Abelino C. Valdez, Tracy, CA (US); Theodore J. Wolcott, Los Altos, CA (US)

(21) Appl. No.: 16/282,256

(22) Filed: Feb. 21, 2019

Related U.S. Application Data
(60) Provisional application No. 62/634,126, filed on Feb. 22, 2018.
(60) Provisional application No. 62/719,561, filed on Aug. 17, 2018.

(51) Int. Cl. H04W 48/18; H04B 10/11; H04W 72/08; H04B 10/27

(52) U.S. Cl. CPC H04W 48/18; H04B 10/271; H04W 72/08; H04B 10/11

(57) ABSTRACT

A node in a hybrid wireless link includes a free space optical (FSO) terminal and a radio frequency (RF) terminal. The FSO terminal is configured to transmit data over an FSO link, and the RF terminal is configured to transmit data over a free space RF link. The node also includes a switch/controller coupled to the FSO terminal and the RF terminal. The switch/controller is configured to receive data and determine at the data link layer whether to transmit data frames of the data over the FSO link, the RF link, or both. The determination is based on the content of the data frames, and, once the determination is made, the switch/controller steers the data frames to the FSO terminal, the RF terminal, or both. In some embodiments, the switch/controller makes the determination at the network layer.

### CROSS-REFERENCE To RELATED APPLICATIONS

This application claims priority to Provisional Patent Application Ser. No. 62/634,126, “Hybrid Wireless Link Employing Free-Space Optical Communication, E-Band Radio Frequency Communication, and Intelligent Packet Switching,” filed on Feb. 22, 2018 and Provisional Patent Application Ser. No. 62/719,561, “Traffic Steering for Hybrid Communication Links,” filed on Aug. 17, 2018, the subject matter of which is incorporated herein by reference in their entirety.

### BACKGROUND

### Technical Field

This description relates to a method of wireless digital communication. Particularly, this description relates to communication between two wireless digital communication nodes. Specifically, the description relates to a technique for wireless digital communication between two nodes, each including an intelligent data switch/controller, a high capacity radio frequency (RF) terminal transmitting and receiving typically at frequencies in the millimeter wave frequency band, and a high capacity free space optics (FSO) terminal transmitting and receiving optically.

### Description of Related Art

Wireless Communication:

Wireless data transmission is a proven technique for transferring information between two points that are not connected by an electrical conductor or optical fiber. While modern communication networks make broad use of fiber optic cables, coaxial cables, and other wired transmission media, wireless communication links continue to be an important part of many networks.

Radio Frequency (RF) wireless links are often found at the edge of communication networks, connecting devices such as cell phones, computers, printers, automobiles, machinery, and many other devices. Those wireless connections tend to operate at relatively low data rates, measured in megabits per second (Mbps), where one (1) megabit equals one million (1,000,000) bits.

RF wireless links can also be found closer to the core of terrestrial communication networks, where data rates can exceed one billion (1,000,000,000) bits per second, or 1 gigabit per second (1 Gbps). These high capacity wireless links connect nodes in a cellular network, often referred to as cell sites, to the core network, an application commonly referred to as ‘cellular backhaul.’ High capacity RF wireless links also connect two or more buildings within an industrial complex, as well as individual or multiple buildings to the core network. They also connect nodes in both metropolitan and long-distance broadband networks.

RF wireless links are often used in terrestrial communication networks when wired links, such as those using fiber optic cables and/or coaxial copper cables, are unfeasible (due to geography, lack of right-of-way, or other barriers), too expensive (due to installation costs, right-of-way costs, license costs, or other costs), too risky (due to the risk of the cable being damaged or broken, either accidentally or purposefully, during installation or after it has been installed), or too slow (due to extended installation timelines). RF wireless links can often be installed in locations where the terrain makes it difficult or impossible to install fiber optic or coaxial copper cable, without the need to obtain or pay for right-of-way, at a much lower cost, and/or much more quickly than fiber optic or coaxial copper cable links.

Wireless links are also used in airborne communication networks, connecting airborne platforms such as fixed wing airplanes, helicopters, dirigibles, balloons, and other airborne platforms to the ground and to each other. Similarly, wireless links are used for communication to, from and between satellites. Given the nature of airborne and satellite communication networks, wired links are not an option. All links in airborne and satellite communication networks are wireless.

The data rate achievable over an RF wireless link is limited by the bandwidth (the range of frequencies in the radio-frequency spectrum) available for the link. Frequencies in the microwave band, between 300 MHz (300,000,000 Hz) and 30 GHz (30,000,000,000 Hz), are commonly used for wireless links. The microwave band is split into different channels, which are often designated for specific uses (such as terrestrial wireless communication, radio or television broadcasting, satellite communication, satellite broadcasting, mobile networking, aeronautical radio navigation, and radio astronomy), managed and licensed by government organizations, such as the Federal Communications Commission (FCC) in the United States. Channels allocated for wireless terrestrial wireless communication typically range from 20 MHz to 80 MHz (20,000,000 Hz). As a result, the data rate achievable by an RF wireless link operating in the microwave band (a microwave link) is limited to less than 1 Gbps (1,000,000,000 bits per second). Typical full duplex rates for high capacity wireless links range from 600 Mbps to 800 Mbps (600,000,000 bits per second to 800,000,000 bits per second).

High order, bandwidth efficient modulation techniques, such as 256 QAM (Quadrature Amplitude Modulation), 1024 QAM, and 2048 QAM, can be employed to increase the data rate associated with a microwave link. But, the increased data rate and bandwidth efficiency significantly reduces the link's tolerance to the effects of weather, such as rain, thereby limiting the distance that can be covered by the microwave link.

E-Band Wireless Communication:

In 2003, the FCC licensed two bands of millimeter-wave (mm Wave) frequencies between 71 GHz and 86 GHz, 71-76 GHz, and 81-86 GHz, for terrestrial RF wireless use. Collectively, these bands are referred to as the E-Band. The E-Band has been made available for terrestrial RF wireless communication by many other countries around the world and will be made available by more countries in the coming years. With a total of 10 GHz of total spectrum available in the E-Band, full-duplex higher data rates are possible by an E-Band wireless link, even when only a portion of the available spectrum is utilized. However, radio waves in this range of frequencies are susceptible to the effect of rain. Rain drops both absorb and scatter E-Band radio waves. As a result, the performance of an E-Band wireless link can be severely degraded when rain is falling between the link's endpoints.

To combat the effects of rain on an E-Band link, the link distance can be limited, requiring multiple E-Band links to cover longer distances, using intermediate nodes as repeaters. Unfortunately, the cost of such a multi-hop E-Band link is much greater than a link that does not require repeaters.

In some parts of the world, use of the E-Band spectrum is free of a license requirement. In other parts, including the US, a license is required to transmit at E-Band frequencies. The cost of such a license, when necessary, tends to be significantly less than that for the use of a microwave channel.

Free-Space Optical Communication:

Free-space optical communication, also referred to as Free Space Optics (FSO), is an alternative to RF wireless communication. Instead of transmitting the data via radio frequency waves, FSO communication transmits the data via light, by modulating the output of a laser at the transmitter and detecting the modulated signal at the receiver. FSO communication is similar to fiber optic communication. Instead of sending the modulated light through an optical cable, the signal is sent through the air, free-space.

FSO system can operate at different wavelengths, including 850 nanometers (nm), 980 nm, within the 1300 nm region (1280 nm to 1310 nm), and within the 1550 nm region (1530 nm to 1565 nm).

FSO communication has many advantages, when compared to E-Band wireless communication. The FSO signal is less sensitive to rain, FSO transmission does not require a license, and the narrow FSO signal is difficult to intercept.

Like an E-Band wireless link, an FSO link can operate at data rates of 10 Gbps or more. Each optical channel, created by modulating an optical signal with a specific wavelength, can carry 10 Gbps of data or more. Multiple optical channels, each a separate optical signal with a unique wavelength, can be combined in an FSO link, to deliver even higher data rates.

Unfortunately, FSO links do not perform well in the presence of fog, smoke, or other phenomena that limit visibility. FSO system can operate at different wavelengths, including the 850 nanometers (nm) region and the 1550 nm region. FSO signals with wavelengths at or around 1550 nm can tolerate poorer visibility than signals with wavelengths at or around 850 nm.

As a result, FSO links tend to be limited in distance to less than 1 km. In order to span longer distances, multiple individual links must be combined into a single multi-hop link, with repeaters at the intermediate nodes.

OSI Model:

The Open Systems Interconnection (OSI) model is a network model, introduced in 1983 by the International Organization for Standardization (ISO) and Comite Consultatif International Téléphonique et Télégraphique (CCITT). The conceptual model standardizes the communication functions of a communication system without regard to the technology used to implement the functions, and allows interoperability between communications devices built in accordance with the model.

The OSI model includes seven (7) layers. Layer one (1) is the physical layer, which function is the transmission and reception of raw bit streams over the physical medium (such as fiber optic cable, copper cable, copper wire, or free-space). Layer two (2) is the data link layer, which function is reliable transmission of data frames between two nodes connected by a physical layer. Layer three (3) is the network layer, which function is structuring and managing a multi-node network, including addressing, routing and traffic control of network packets. Layer four (4) is the transport layer, which function is reliable transmission of network packets between two points on a network. Layer five (5) is the session layer, which function is managing communication sessions (continuous exchange of information in the form of multiple back-and-forth transmissions between two nodes). Layer six (6) is the presentation layer, which function is translation of data between a networking service and an application. And, layer seven (7) is the application layer, which function is process-to-process communication across a network, including communication and user interfaces.

Increasing Capacity Demands:

A rapid increase in the number of devices, such as cell phones and computers, and data-hungry applications, such as over-the-air streaming applications like Netflix, the data rates at which networks operate is increasing, from the network edge through the network the core and to/from data centers and other data sources. Traditional microwave communication links cannot support the increased data rate demand and FSO communication links cannot operate reliably over distances greater than 1-2 km.

### SUMMARY

The method and the system of this description center around a hybrid wireless link that includes a combination of a Free-Space Optics (FSO) wireless data communication link and an E-Band radio frequency (RF) wireless data communication link. The hybrid wireless link provides a means to communicate through a free space channel between two nodes in a communication network. The hybrid wireless link allows data to be transmitted across the hybrid wireless link (e.g., at data rates up to 20 Gbps) in a wide range of weather conditions including heavy fog and rain for distances of 2-5 km or longer.

The hybrid wireless link can be used to connect two nodes (point-to-point) in a terrestrial communication network or in an airborne communication network (air-to-ground and/or air-to-air).

The hybrid wireless communication link connects two nodes, with the first node at one end of a free space (wireless) channel, and the second node some distance away at the other end of the free space channel. Each node in the hybrid wireless communication link includes three major subsystems: an FSO terminal, an E-band RF terminal, and a switch/controller. Each node also includes other subsystems, such as: a node controller, responsible for configuration and management of subsystems within a node; an switching component; a data link protocol component; a network interface, used to accept and deliver data from and to the rest of the communication network; terminal interfaces, used to accept and deliver data and command/control traffic between the switch/controller and other terminals; a management interface, which is used by the operator or higher-level controller to configure the node/link and manage the node/link; one or more power supplies; and one or more equipment mounts, each used to mount one or more piece of equipment onto a tower, building or other location. Each node, depending on the embodiment, may also include one or more data distribution cables, delivering data between the switch/controller and one or more of the terminals; one or more control/management distribution cables, distributing control and management traffic between the switch/controller and one or more of the terminals; one or more power distribution cables, delivering power between the power supply and one or more of the major subsystems; and/or one or more integrated cables (which combine data distribution, control/management distribution, and/or power distribution into a single cable).

When describing a single node, subsystems within the node are referred to as ‘local’ while subsystems within the node at the far end of the link are referred to as ‘remote.’

The switch/controller includes the node controller, the management interface, the network interface, the switching component, the data link protocol component, and a terminal interface.

The node controller controls the configuration and operation of the local node, including its subsystems. The node controller also communicates with the operator or a higher-level controller via the management interface, which may include so-called northbound management interfaces, such as a command line interface (CLI), a graphical user interface (GUI), a Simple Network Management Protocol (SNMP) interface, and a Network Configuration Protocol (NETCONF) interface.

The network interface interfaces with the surrounding communication network, accepting data to be transmitted to the remote node and delivering data received by the local node. The network interface includes a variety of interfaces. In an embodiment, the network interface includes a combination of Gigabit Ethernet/GigE (as specified by IEEE Standard 802.3z, operating at 1.0 Gbps) and 10 Gigabit Ethernet (as specified by IEEE Standard 802.3ae, operating at 10.0 Gbps).

The switching component is responsible for performing data frame switching functions (layer 2 functions), including the identification of traffic flows (e.g., by port and VLAN), performing traffic policing on those flows, switching flows to the data link protocol component, and performing traffic shaping. The data link protocol component also performs traffic shaping when the available capacity of either the FSO or E-Band Link E (also referred to as the RF link) is degraded.

The data link protocol component implements the data link protocol and is responsible for managing the delivery of data traffic across the link, including managing which data frames, bytes, or bits are sent to the E-Band terminal for transmission, the FSO terminal for transmission, or both for redundant transmission. The data link protocol may also manage retransmission, in the event of lost data frames.

The terminal interface on the switch/controller may deliver a user data stream and a management data stream to both the FSO terminal and the E-Band terminal. The E-Band terminal may also be referred to as the RF terminal and the E-Band terminal is not limited to E-Band signals.

Each FSO terminal may include a transmitter, a receiver, a terminal controller, and a terminal power unit, along with data, management, and power interfaces. Each E-Band terminal includes a transmitter, a receiver, a terminal controller, and a terminal power unit, along with data, management and power interfaces.

Each FSO terminal transmitter modulates and transmits one or more optical carriers (optical signals) with processed user data and overhead data. Overhead data includes data streams being sent from the local switch/controller to the remote terminal's switch/controller (command/control data) and from the local FSO terminal controller to the remote FSO terminal controller (terminal-to-terminal data). The transmitter processes these three data streams (user data, command/control data, and terminal-to-terminal data) in preparation for transmission. Processing may include scrambling, interleaving, forward error correction coding, and/or data framing, to create a single transmit data stream. The transmit data stream is then used to modulate the collimated optical carrier generated by a laser, which is amplified, processed by an optical processor and then transmitted through a transmit aperture through the air (free space) to the remote FSO terminal.

Each FSO terminal receiver receives and demodulates the optical signal transmitted by the remote FSO terminal. The received optical signal is accepted through a receive aperture, processed by an optical processor, amplified, and demodulated to recover the received data stream. The received data stream is then processed to recover the received user data stream, command/control data stream, and terminal-to-terminal data stream. Processing may include de-framing, forward error correction decoding, de-interleaving and/or descrambling. The received user data stream and control command/control data stream are delivered by the FSO terminal receiver to the switch/controller, while the received terminal-to-terminal data stream is delivered to the FSO terminal controller.

Each E-Band terminal transmitter modulates and transmits one or more RF carriers (RF signals) with processed user data and overhead data. Similar to the overhead data received by the FSO terminal, overhead data includes data streams being sent from the local switch/controller to the remote terminal's switch/controller and from the local terminal controller to the remote terminal controller. The transmitter processes the three data streams (user data, command/control data, and terminal-to-terminal data) in preparation for transmission. Processing may include scrambling, interleaving, forward error correction coding, and/or data framing, to create a single transmit data stream. The transmit data stream is then used to modulate an E-Band RF carrier (or any other RF carrier), which is amplified and then transmitted via an E-Band antenna through the air (free space) to the remote E-Band terminal.

Each E-Band terminal receiver receives and demodulates the E-Band RF signal transmitted by the remote E-Band terminal. The received E-Band RF signal is accepted via the E-Band antenna, amplified, and demodulated to recover the received data stream. The received data stream is then processed to recover the received user data stream, command/control data stream, and terminal-to-terminal data stream. Processing may include de-framing, forward error correction decoding, de-interleaving and/or descrambling. The received user data stream and control command/control data stream are delivered by the E-Band terminal receiver to the switch/controller, while the received terminal-to-terminal data stream is delivered to the E-Band terminal controller.

Embodiments relate to a local node that provides a hybrid wireless link to a remote node. The local node includes a free space optical (FSO) terminal, a radio frequency (RF) terminal, and a switch/controller. The FSO terminal is configured to transmit data to the remote node over a free space optical link. The RF terminal is configured to transmit data to the remote node over a free space RF link. The free space optical link and the free space RF link together form the hybrid wireless link between the local node and the remote node. The switch/controller is coupled to the FSO terminal and to the RF terminal. The switch/controller is configured to receive data. The switch/controller is also configured to determine at the data link layer whether to transmit data frames of the data over the free space optical link and/or over the free space RF link where the determination is based on a content of the data frames. The switch/controller is also configured to steer the data frames to the FSO terminal and/or to the RF terminal based on the determination.

In some embodiments, the switch/controller implements a data link protocol for hybrid wireless links. In these embodiments, the data link protocol may be a proprietary protocol. In some embodiments, the switch/controller determines at the data link layer whether to transmit data frames over the free space optical link and/or over the free space RF link based on at least one of: ingress port, egress port, MAC source address, MAC destination address, EtherType, outer 802.1Q tag VLAN ID, outer 802.1Q tag PCP, outer 802.1Q tag DEI, inner 802.1Q tag VLAN ID, inner 802.1Q tag PCP, inner 802.1Q tag DEI, IPv4 source address, IPv4 destination address, IPv4 DSCP, IPv4 ECN, IPv4 protocol field, IPv6 source address, IPv6 destination address, IPv6 traffic class, IPv6 Next Header, IPv6 flow label, IPv6 SRH, outer MPLS tag label, outer MPLS tag EXP (QoS or ECN), one or more inner MPLS tag labels, or one or more inner MPLS tags EXP (QoS or ECN). In some embodiments, the switch/controller determines at the data link layer whether to transmit data frames over the free space optical link and/or over the free space RF link based further on a condition of the hybrid wireless link, the condition of the hybrid wireless link including at least one of: instantaneous or time averaged throughput; frame loss ratio; latency; jitter; link utilization; expected or calculated link availability; link state (link up or down); predicted link performance based on link location, time of day, time of year; or measured, reported, or estimated atmospheric conditions. In some embodiments, the switch/controller is configured to steer individual data frames alternately to the free space optical link and to the free space RF link.

In some embodiments, the switch/controller comprises a switching component and a data link protocol component. The switching component is configured to receive data frames and perform data link layer functions on the data frames. The data link protocol component is coupled to receive the data frames from the switching component and steer the data frames to the FSO terminal and/or to the RF terminal. In some embodiments, none of the data link layer functions performed by the switching component are specific to hybrid wireless links. In some embodiments, the switching component performs at least one of identifying traffic flows, traffic policing of traffic flows, switching traffic flows to the data link protocol component, and traffic shaping. In some embodiments, the switching component determines a class of service for data frames based on the content of the data frames, and whether to transmit the data frames over the free space optical link and/or over the free space RF link is based on the class of service. In some embodiments, the switching component determines a quality of service for data frames based on the content of the data frames, and whether to transmit the data frames over the free space optical link and/or over the free space RF link is based on the quality of service. In some embodiments, the switching component determines a traffic treatment for data frames based on the content of the data frames, and whether to transmit the data frames over the free space optical link and/or over the free space RF link is based on the traffic treatment. In some embodiments, the data link protocol component performs all of the data link layer functions that are specific to hybrid wireless links. In some embodiments, the data link protocol implements a plurality of traffic treatments assigned to the data frames, and the data link protocol component steers the data frames to the FSO terminal and/or to the RF terminal based on the traffic treatment assigned to the data frame. In some embodiments, wherein traffic treatments are assigned to data frames based on at least one of VLAN tag, port number, and traffic type. In some embodiments, the switching component produces tags for the data frames based on their content, and the data link protocol component steers the data frames to the FSO terminal and/or to the RF terminal based on a lookup table that maps the tags to the FSO terminal and/or the RF terminal. In some embodiments, the data link protocol component manages retransmission of data frames in an event of lost data.

In some embodiments, the hybrid wireless link is bidirectional. In some embodiments, the local node and the remote node are part of a network with additional other nodes. In some embodiments, the FSO terminal and the RF terminal are co-located within 10 feet of each other. In some embodiments, the free space optical link has a nominal data rate of at least 10 Gbps. In some embodiments, the local node and the remote node are located at least 4 km apart. In some embodiments, the free space optical link operates in an infrared wavelength range and the free space RF link operates in an E-band.

Embodiments also relate to a local node that provides a hybrid wireless link to a remote node. The local node includes and physical layer and a data link layer. The physical layer includes a free space optical (FSO) terminal and a radio frequency (RF) terminal. The FSO terminal is configured to transmit data to the remote node over a free space optical link. The RF terminal is configured to transmit data to the remote node over a free space RF link. The free space optical link and the free space RF link together form a hybrid wireless link between the local node and the remote node. The data link layer determines whether data frames of the data are transmitted to the remote node over the free space optical link and/or over the free space RF link.

Embodiments also relate to a local node that provides a hybrid wireless link to a remote node. The local node includes a free space optical (FSO) terminal, a radio frequency (RF), and a controller. The FSO terminal is configured to transmit data to a remote node over a free space optical link. The RF terminal is configured to transmit data to the remote node over a free space RF link. The free space optical link and the free space RF link together form a hybrid wireless link between the local node and the remote node. The controller is coupled to the FSO terminal and to the RF terminal. The controller is configured to receive data. The controller is also configured to determine at the data link layer and/or the network layer whether to transmit data frames and/or network packets of the data over the free space optical link and/or over the free space RF link. The determination is based on a content of the data frames and/or network packets. The controller is also configured to steer the data frames and/or network packets to the FSO terminal and/or to the RF terminal based on the determination.

Other aspects include components, devices, systems, improvements, methods, processes, applications, computer readable mediums, and other technologies related to any of the above. Examples include transceivers and bi-directional links.

### BRIEF DESCRIPTION OF DRAWINGS

Embodiments of the disclosure have other advantages and features which will be more readily apparent from the following detailed description and the appended claims, when taken in conjunction with the examples in the accompanying drawings, in which:

FIG. 1 is a block diagram of a local node and a remote node communicating via an optical channel and a radio frequency channel, according to an embodiment.

FIG. 2 is a block diagram of a switch/controller unit, according to an embodiment.

FIG. 3 is a block diagram of a free-space optical (FSO) terminal, according to an embodiment.

FIG. 4 is a block diagram of the E-Band terminal, according to an embodiment.

FIG. 5 is a block diagram of a local node and a remote node, wherein the switch/controller units for each node are installed in sheltered locations and the FSO and E-Band terminals for each node are mounted on external structures, according to an embodiment.

FIG. 6 is a block diagram of a local node and a remote node, wherein the switch/controller units for each node are installed on external structures, according to an embodiment.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

This description relates to a method of wireless digital communication. Particularly, this description relates to communication between two wireless digital communication nodes. More particularly, this description relates to communication between two digital communication nodes, each consisting of a switch/controller and two wireless communication terminals. More particularly, this description relates to communication between two digital communication nodes, each employing two different wireless digital communications technologies, operating in parallel for improved weather tolerance. More particularly, this description relates to wireless communication. More particularly, this description relates to wireless communication between nodes that are mounted on building sides, towers, other structures, ships, or airborne platforms such as airplanes, balloons, dirigibles, and other fixed- or non-fixed-wing aircraft. Specifically, the description relates to a technique for wireless digital communication between two nodes, each including a switch/controller, a millimeter wave (mm Wave) radio frequency terminal transmitting and receiving at frequencies in the millimeter wave frequency band, and a free space optics (FSO) terminal transmitting and receiving optically.

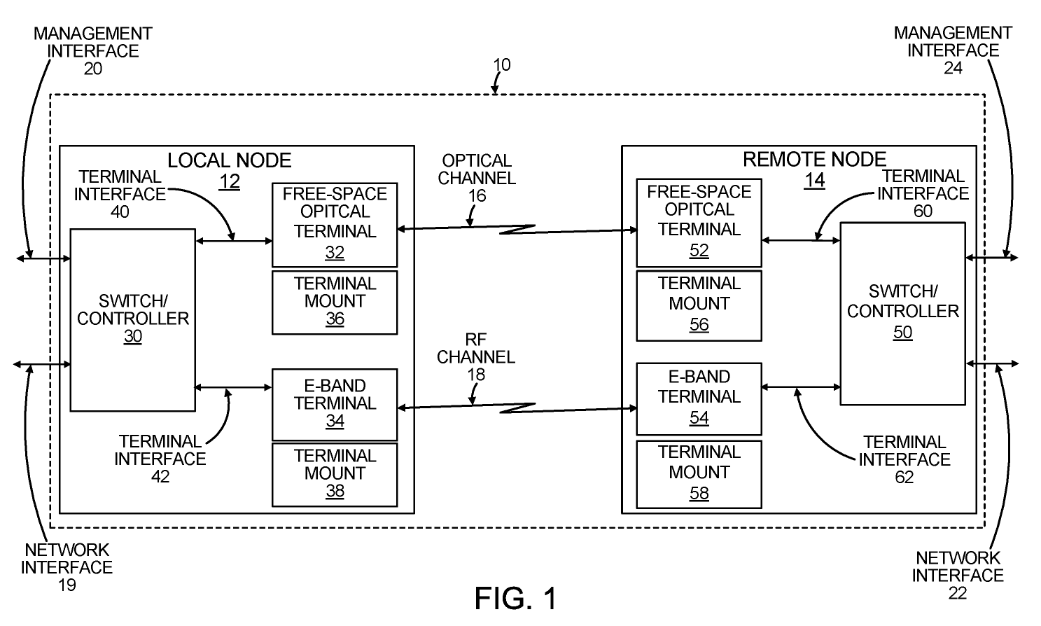

FIG. 1 is a block diagram of a local node 12 and a remote node 14 communicating via a hybrid wireless link 10 that includes an optical channel 16 and a radio frequency channel 18, according to an embodiment. The local node 12 and remote node 14 may be a part of high capacity wireless communication networks such as cellular networks, broadband networks, air-to-ground networks, air-to-air networks, and other data networks employing high capacity wireless links. The hybrid wireless link 10 employs two free-space communications technologies, free-space optical (FSO) communication and radio frequency (RF) communication. Each technology is capable of transmitting and receiving data between two sets of apparatus (nodes) without the use of wired communication media such as copper wire, coaxial cable, or fiber optic cable. In alternative configurations, different, and/or additional components may be included in FIG. 1. Furthermore, the components in the block diagram may be deployed in one or more physical devices and embodied in software, firmware, hardware, or any combinations thereof.

FSO communication and RF communication are each effected by weather, which can cause transmission errors (bit errors) and/or halt communication. FSO communication is generally affected by weather that causes reduced visibility (e.g., weather which disturbs or absorbs light waves), and RF communication is generally affected by weather that causes absorption or scattering of RF waves, especially as the transmission frequency increases.

When employed together, FSO communication and RF communication provide improved tolerance to the effects of weather on the communication link than either technology alone.

The hybrid wireless link 10 also employs data frame switching (layer 2) and/or network packet routing (layer 3) to allocate the traffic flow between the optical channel 16 and the radio frequency channel 18. Data frame switching and network packet routing allows data to be delivered between two nodes in a network across one or more links. Data frame switching and network packet routing, features delivery of variable bit rate data streams, realized as sequences of data frames or network packets, over a computer or data network which allocates transmission resources as desired using statistical multiplexing or dynamic bandwidth allocation techniques. The treatment of these data frames or network packets is based on their content, traffic type, priority, and other attributes of the data carried within the data frame or network packet. This switching applies different rules to different data frames or network packets, based on those attributes, to deliver the data frames or network packets with appropriate latency, priority, and protection. As a result, the combination of FSO communication, RF communication, and data frame switching and/or network packet routing provides significant advantages in wireless communication.

The hybrid wireless link 10 includes two nodes, one designated as the local node 12 and one designated as the remote node 14. The two nodes are connected by an optical channel 16 and a radio frequency channel 18. Digital data is transmitted between the local node 12 and the remote node 14 and from the remote node 14 to the local node 12 across both the optical channel 16 and the radio frequency channel 18. Data transmitted between the nodes includes a combination of user data and overhead data. Overhead data includes various management data that allows communication between subsystems within each node.

In an embodiment, the RF communication technology operates at frequencies between 71 gigahertz (GHz) and 86 GHz. In an embodiment, the RF communication technology of the local node 12 transmits at a center frequency between (transmit frequency) 71 GHz and 76 GHz and receives at a center frequency (receive frequency) between 81 GHz and 86 GHz while the remote node 14 operates with a receive frequency matched to the local nodes transmit frequency and a transmit frequency matched to the local nodes receive frequency.

In alternate embodiments, the RF communication technology can operate at frequencies between 40 GHz and 71 GHz. In alternate embodiments, the RF communication technology can operate at frequencies between 71 GHz and 110 GHz.

In an embodiment, both the FSO communication technology (the FSO link) and the RF communication technology (the E-Band link or the RF link) operate at a nominal data rate of 10 gigabits per second (Gbps). In these embodiments, the data transmitted across a link is typically at or above 10 Gbps (e.g., within 2 Gbps). However, because the data includes overhead data, the data rate for user data may be slightly below 10 Gbps (e.g., within 2 Gbps). In another embodiment, the FSO link operates at a nominal data rate of 10 Gbps and the E-Band link operates at a nominal data rate between 2.5 Gbps and 5 Gbps. In some embodiments, the FSO link operates in an infrared wavelength range and the RF link operates in an E-Band range.

The local node 12 includes a network interface 19 and a management interface 20. Similarly, the remote node 14 includes a network interface 22 and a management interface 24. Both network interfaces serve to a) accept digital data to be transmitted across the hybrid link, and b) deliver digital data that has successfully been transmitted across the hybrid link. The management interfaces allow the nodes and the link to be configured and monitored by a management channel. For example, the management interfaces provide information, such as timing signals, necessary to operate as part of a larger network. Since overhead data can be communicated between the nodes, a management channel between the two nodes allows both the local node 12 and remote node 14 to be configured and monitored (managed) via the management interface 20 at the local node 12 and the management interface 24 at the remote node 14.

The local node 12 includes a switch/controller subsystem 30, an FSO terminal 32, an E-Band terminal 34, a terminal mount for the FSO terminal 36, and a terminal mount for the E-Band terminal 38. The switch/controller 30 is communicatively coupled to the FSO terminal 32 and the E-Band terminal 34, and the terminal mounts physically connect the terminals to the building or structure on which the terminals are installed.

The switch/controller 30 accepts user data to be transmitted to the remote node across the hybrid link and delivers data that has been successfully received by the local node via the network interface 19. The switch/controller 30 accepts configuration commands, timing signals, and other information and provides status, alarms, and other information, via the management interface 20. The switch/controller 30 also accept similar communication information via the management channel, conveyed over both the FSO link and the E-Band link between the two nodes. This allows the local node 12 to be managed via the local node's management interface 20 or the remote node's management interface 24.

The switch/controller 30 communicates with the FSO terminal 32 over a terminal interface 40. The switch/controller 30 communicates with the E-Band terminal 34 over a second terminal interface 42. A combination of user data and management data is transferred, in both directions, between the switch/controller 30 and both the FSO terminal 32 and the E-Band terminal 34, across the terminal interfaces 40 and 42.

The switch/controller 30 is configured to receive data (e.g., from the network interface 19 and the management interface 20) to be transmitted to the remote node 14. The switch/controller 30 determines at layer 2 whether frames of the data will be transmitted over the optical channel 16, the RF channel 18, or both. The determination is based on the content of the data frames, and, in some implementations, the determination may be made separately for each individual frame of the data. Once the determination is made, the switch/controller 30 provides the data frames assigned to the optical channel 16 to the FSO terminal and the individual frames assigned to the RF channel 18 to the E-Band terminal. In some embodiments, the switch/controller 30 determines at layer 3 how each network packet of the data will be transmitted. In these embodiments, the determination is made based on the content of the packets.

The content of the data frames or network packets that may affect the layer 2 or layer 3 determination may include user data and overhead data. For example, the determination is based on ingress port, egress port, MAC source address, MAC destination address, EtherType, outer 802.1Q tag VLAN ID, outer 802.1Q tag PCP, outer 802.1Q tag DEI, inner 802.1Q tag VLAN ID, inner 802.1Q tag PCP, inner 802.1Q tag DEI, IPv4 source address, IPv4 destination address, IPv4 DSCP, IPv4 ECN, IPv4 protocol field, IPv6 source address, IPv6 destination address, IPv6 traffic class, IPv6 Next Header, IPv6 flow label, IPv6 SRH, outer MPLS tag label, outer MPLS tag EXP (QoS or ECN), any inner MPLS tag label, any inner MPLS tag EXP (QoS or ECN), or higher layer protocol information. Additional examples include customer defined link priority, overhead link management data, and whether the data frames or network packets have already been transmitted and need to be retransmitted.

In addition to content of the data frames or network packets, the determination to transmit each frame or packet over the optical channel 16, the RF channel 18, or both may be based on a condition of the hybrid wireless link 10, such as instantaneous or time averaged throughput; data frame loss ratio; latency; jitter; link utilization; expected or calculated link availability; link state (link up or down); predicted link performance based on link location, time of day, time of year; and measured, reported, or estimated atmospheric conditions. Additional examples include RF link and FSO link quality status updates. These may be based on remote or local indicators of transmit quality and retransmission queues. For example, if the atmospheric conditions indicate that heavy fog is between the local and remote node, the data may be transmitted over the RF channel 18. In another example, if the RF channel 18 consistently has a low throughput during sunrise, data may be transmitted over the optical channel 16 during sunrise.

The remote node 14 includes the same major subsystems, including a switch/controller 50, an FSO terminal 52 and its terminal mount 56, an E-band terminal 54 and its terminal mount 58. Similar to the local node 12, the switch/controller 50 in the remote node 14 communicates with the FSO terminal 52 and the E-Band terminal 54, via terminal interfaces 60 and 62.

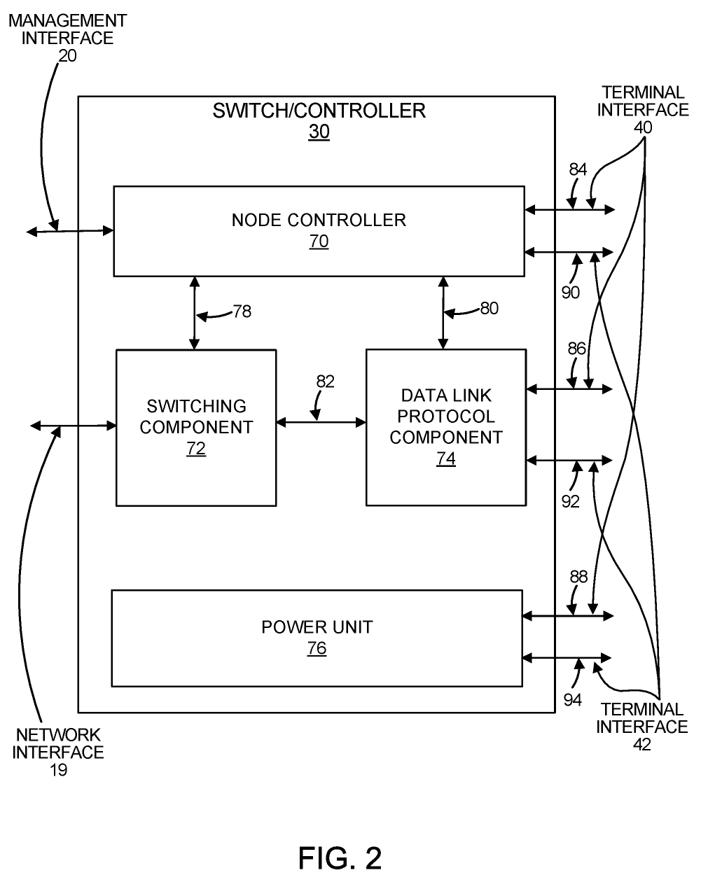

A block diagram of the switch/controller 30 is shown in FIG. 2, according to an embodiment. The switch/controller 30 includes a node controller 70, a switching component 72, a data link protocol component 74, and a power unit 76. Data to be transmitted by the local node 12 to the remote node 14 over the hybrid link 10 is accepted by the switch/controller 30 via the network interface 19. Data received by the local node 12 from the remote node 14 is delivered via the network interface 19. Configuration commands are accepted by the switch/controller 30 and status, performance, and alarms are provided via the management interface 20. The switch/controller 30 interfaces with the FSO terminal 32 via a terminal interface 40 and the E-Band terminal 34 via a second terminal interface 42. In alternative configurations, different, and/or additional components may be included in FIG. 2. Furthermore, the components in the block diagram may be deployed in one or more physical devices and embodied in software, firmware, hardware, or any combinations thereof.

The node controller 70 also functions as the control plane processor, and control plane frames or packets can be received or transmitted over interface 19, transferred to or from the node controller over 78, and processed in the node controller 70.

The node controller 70 is responsible for configuration and control of the local node. The node controller 70 also communicates with the node controller in the remote node 14 via a node-to-node management channel multiplexed into the data stream transmitted across the hybrid link 10. Communication information, such as management commands and status, performance, and alarm information, are received and transmitted by the node controller 70 via the local management interface 20. The node controller 70 may also receive and transmit communication information from/to the remote node 14 via the node-to-management channel. Interfaces provided by the node controller 70 include: Network Configuration Protocol (NETCONF), as defined by the Internet Engineering Task Force (IETF) for status and configuration of the node; Simple Network Management Protocol (SNMP), for status, performance and alarms; and a command line interface (CLI). The node controller 70 also provides a web-based graphical user interface (GUI) over the management interface 20.

The node controller 70 sends configuration commands to and receives status, performance and alarms from the FSO terminal 32 via the terminal interface 84. Similarly, the node controller 70 sends configuration commands to and receives status, performance and alarms from the E-Band terminal 34 via the terminal interface 90. In an embodiment, the management interfaces 84 and 90 operate at data rates of at least 1 Gbps. Further, in an embodiment, the management interfaces 84 and 90 GigE interfaces with power-over-Ethernet (PoE).

The node controller sends command to and receives status, performance and alarms from the switching component 72 over a dedicated interface 78. The node controller sends commands to, and receives status, performance and alarms from, the data protocol processor over a dedicated interface 80. The node-to-node management channel from the local node controller 70 to the node controller in the remote node 14 is also delivered/received via the interface 80.

In an embodiment, the node controller 70 is implemented as a plurality of software entities executing on a standard central processing unit (CPU) application specific standard part (ASSP).

The switching component 72 may be configured to perform a variety of data frame switching and network packet routing functions (e.g., layer 2, layer 2.5, and layer 3 functions). These functions may not be specific to hybrid wireless links. For example, the functions may include: identification of traffic flows by port number or VLAN identifier; traffic policing on those traffic flows; switching traffic flows to and from the data link protocol processor; and traffic shaping. The switching component 72 accepts configuration commands from and delivers status, performance, and alarm information to the node controller 70 via a dedicated interface 78. In some embodiments, the switching component 72 is implemented as a layer 2 and layer 3 ASSP. In some embodiments, the switching component 72 determines whether to transmit the data frames over the FSO link, the RF link, or both. Alternatively, the data link protocol component 74 may make this determination.

The switching component 72 may calculate and assign a class of service, a quality of service, and/or a traffic treatment for one or more data frames based on the content of the frames. If so, the determination whether to transmit the data frames over the FSO link, the RF link, or both may be based on the class of service, quality of service, and/or the traffic treatment determinations. For example, if the FSO link has a higher reliability than the RF link, data frames assigned with higher priorities are transmitted via the FSO link (or via both links) and data frames assigned with lower priorities are transmitted via the RF link.

In some embodiments, the switching component 72 tags data frames according to their content. In these embodiments, the data link protocol component 74 steers the data frames to the FSO link, the RF link, or both based on a lookup table that maps the tags to one or more links.

The switching component 72 accepts user traffic to be transmitted over the hybrid wireless link to the remote node 14 via the network interface 19. The switching component 72 also delivers user traffic received over the hybrid wireless link from the remote node 14 via the network interface 19. The network interface 19 includes a plurality of bi-directional data ports. In an embodiment, the network interface 19 includes a plurality of Gigabit Ethernet (GigE) data ports and a plurality of 10 Gbps Ethernet data ports (10 GigE) data ports. In an embodiment, the aggregate capacity of the network interface 19 data ports is greater than the total combined capacity of 20 Gbps available over the FSO link and E-Band link.

The switching component 72 delivers data (e.g., data frames or network packets) to the data link protocol component 74 via a dedicated interface 82 in order for that data to be transmitted over the hybrid link to the remote node 14. The switching component 72 also receives data from the data link protocol component 74 over the same dedicated link 82, after the data was received over the hybrid link from the remote node 14. In some embodiments, the interface 82 between the switching component 72 and the data link protocol component 74 operates at 20 Gbps or more in each direction (e.g., full duplex).

The data link protocol component 74 implements a data link protocol to orchestrate the traffic flows across both the FSO link and the E-Band link. The data link protocol may be a proprietary protocol. By executing the protocol, the data link protocol component 74 may steer individual data frames (or network packets) to the FSO terminal 32 and the E-Band terminal 34. When transmitting data, the data link protocol component 74 implement a number of traffic treatments assigned to the data frames (e.g., frame priority). Based on the assigned traffic treatments, the data frames may be steered to the FSO link, RF link, or both links. For example, data frames assigned to a higher priority traffic treatment are given precedence over frames assigned to a lower priority traffic treatment. The data link protocol component 74 considers many factors to assign a traffic treatment to each frame. These factors may include VLAN tag, port number, and traffic type, among others. When receiving data, the data link protocol considers the assigned traffic treatment to assure timely and accurate delivery of the received frames.

The data link protocol component 74 sends data, including the user data and management channel data, to be transmitted over the FSO link to the FSO terminal 32 via the terminal interface 86 and sends data to be transmitted over the E-Band link to the E-Band terminal 34 via the terminal data interface 92. In an embodiment, interfaces 86 and 92 operate at peak data rates of at least 10 Gbps. Further, in an embodiment, the interfaces 86 and 92 are 10 GigE interfaces.

In an embodiment, the data link protocol component 74 is implemented as a plurality of software entities executing on a multi-core network processor unit (NPU) ASSP. In a different embodiment, the data link protocol component 74 is implemented in a field programmable gate array (FPGA). In a different embodiment, the data link protocol component 74 is implemented in silicon as an application specific integrated circuit (ASIC). In other embodiments, the data link protocol component 74 is implemented as a combination of software entities running on an NPU or CPU together with an FPGA or an ASIC.

The power unit 76 accepts power from a power source and provides power to both the FSO terminal 32 via a dedicated power interface 88 and to the E-Band terminal 34 via a second dedicated power interface 94. In an embodiment, the power unit 76 accepts power from either an alternating current (AC) power source operating at voltages between 100 volts and 240 volts or a direct current (DC) power sources operate at a nominal voltage of negative 48 volts. In an embodiment, the power unit 76 provides power at a nominal voltage of positive 48 volts to the both the FSO terminal 32 via the PoE equipped GigE management interface 84 and to the E-Band terminal 34 via the PoE equipped GigE management interface 90.

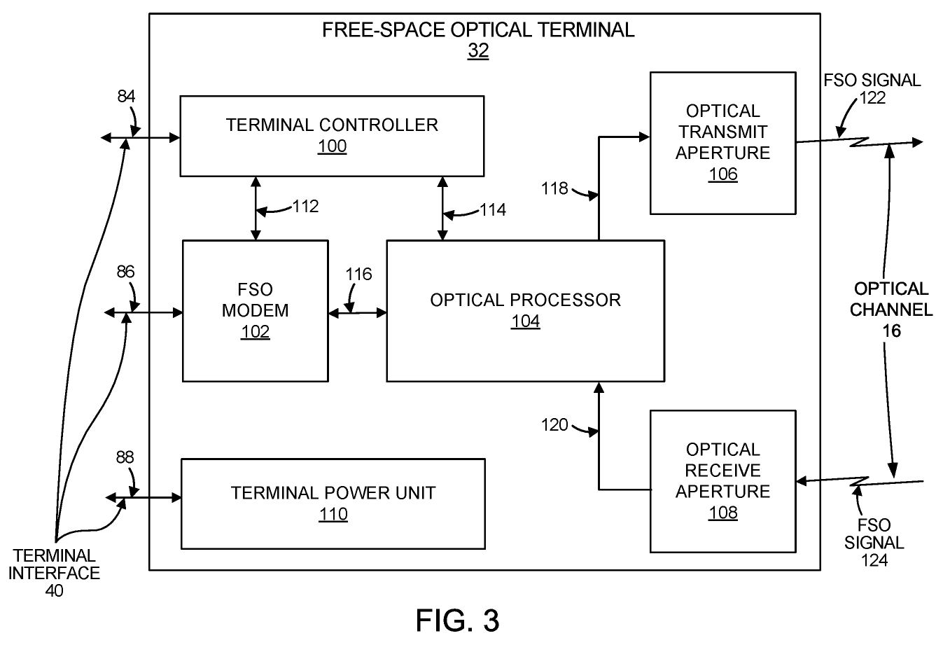

FIG. 3 shows a block diagram of the FSO terminal 32, according to an embodiment. The FSO terminal 32 includes a terminal controller 100, an FSO modulator/demodulator (modem) 102, an optical processor 104, an optical transmit aperture 106, an optical receive aperture 108, and a terminal power unit 110. The FSO terminal 32 interfaces with the switch/controller 30 via the terminal interface 40. The FSO terminal 32 transmits a modulated FSO signal 122 over the free space optical channel 16 to the remote node 14. It also receives a modulated FSO signal 124 over the free space optical channel 16 that was sent from the remote node 14. In alternative configurations, different, and/or additional components may be included in FIG. 3. Furthermore, the components in the block diagram may be deployed in one or more physical devices and embodied in software, firmware, hardware, or any combinations thereof.

The FSO terminal controller 100 is responsible for configuring and monitoring the FSO terminal. It receives configuration commands from and provides status, performance, and alarm information to the node controller 70 via the management interface 84 portion of the terminal interface 40. The terminal controller 100 delivers configuration commands to and receives status, performance, and alarm information from the FSO modem 102 via a dedicated interface 112. The terminal controller 100 also provides FSO management data, to be multiplexed into the transmitted data, to the FSO modem 102 and receives FSO management data, demultiplexed from the received data, from the FSO modem 102 over the same dedicated interface 112. The terminal controller 100 delivers configuration commands to and receives status, performance, and alarm information from the optical processor 104 via another dedicated interface 114.

The FSO modem 102 is responsible for modulating and amplifying light emitted from a laser source. In an embodiment, the FSO modem 102 performs data processing functions, including framing, interleaving, and forward error correction (FEC) coding, prior to modulating the laser light. Further, in an embodiment, the FSO modem 102 employs on-off-keying (OOK) modulation to modulate the laser light. In an alternate embodiment, the FSO modem 102 employs coherent, quadrature amplitude modulation (QAM) instead of OOK modulation. In an embodiment, the FSO modem 102 modulates the laser light at a data rate sufficient to transmit at least 10 Gbps of user data plus overhead data including management channel data and FEC overhead.

The amplified, modulated laser light is delivered to the optical processor via an optical interface 116.

In an embodiment, the FSO modem 102 modulates light characterized by a wavelength within the 1550 nanometers (nm) region (1530 nm to 1565 nm). More particularly, in an embodiment, the FSO modem 102 modulates light characterized by a wavelength specified by the International Telecommunications Union (ITU) as one of the wavelengths on the DWDM grid with 100 GHz spacing. In an alternate embodiment, the FSO modem 102 operates at a wavelength of 850 nm, 980 nm, or within the 1300 nm region (1280 nm to 1310 nm).

In an embodiment, the FSO modem 102 employs an erbium doped fiber amplifier (EDFA) to amplify the modulated laser light.

The FSO modem 102 is also responsible for amplifying, detecting, and demodulating light received by the FSO Terminal 32. The received signal is provided by the optical processor 104 to the FSO modem 102 via the optical interface 116.

In some embodiments, the FSO modem 102 employs an erbium doped fiber amplifier (EDFA) to amplify the received light, prior to detection and demodulation. In some embodiments, the FSO modem 102 employs an avalanche photo diode (APD) to detect the amplified received light, prior to demodulation. In some embodiments, the FSO modem 102 performs data processing functions, including de-framing, de-interleaving, and forward error correction (FEC) decoding, after demodulating the received light. Further, in some embodiments, FSO modem 102 employs on-off-keying (OOK) demodulation to demodulate the received light. In an alternate embodiment, the FSO modem 102 employs coherent, quadrature amplitude demodulation (QAM) instead of OOK demodulation. In some embodiments, the FSO modem 102 demodulates the laser light at a data rate sufficient to transmit at least 10 Gbps of user data plus overhead data including management channel data and FEC overhead.

The FSO modem 102 accepts data to be transmitted from the switch/controller unit 30 via the data interface 86 portion of the terminal interface 40. It also accepts FSO management data from the terminal controller 100 and then multiplexes the management data into the transmit data stream prior to modulation.

The optical processor 104 prepares the amplified and modulated laser light (transmit signal) for transmission and prepares the received light (receive signal) prior to amplification, detection, and demodulation by the FSO modem 102. The optical processor 104 accepts the transmit signal from the FSO modem 102 and delivers the receive signal to the FSO modem 102 via optical interface 116. After preparation, the transmit signal is sent by the optical processor 104 through the optical transmit aperture 106 toward the remote node 14 via an optical interface 118. Similarly, the optical processor 104 first accepts the receive signal from the remote node 14 through the optical receive aperture 108 via an optical interface 120.

In some embodiments, the optical transmit aperture 106 and the optical receive aperture 108 are the same (e.g., the FSO terminal 32 is co-boresighted). Further, in some embodiments, the optical processor 104 performs active pointing and tracking to maintain accurate pointing between the FSO terminal 32 and the remote node 14.

In some embodiments, the FSO terminal 32 generates and transmits single optical signals to the remote node 14 (and similarly receives and processes single optical signals from the remote node 14). In another embodiment, the FSO terminal 32 generates and transmits multiple optical signals to the remote node 14 (and similarly receives and processes multiple optical signs from the remote node 14). In these embodiments, as described above, the FSO terminal 32 may use multiplexing (and demultiplexing) techniques such as wavelength division multiplexing (WDM) or dense wavelength division multiplexing (DWDM).

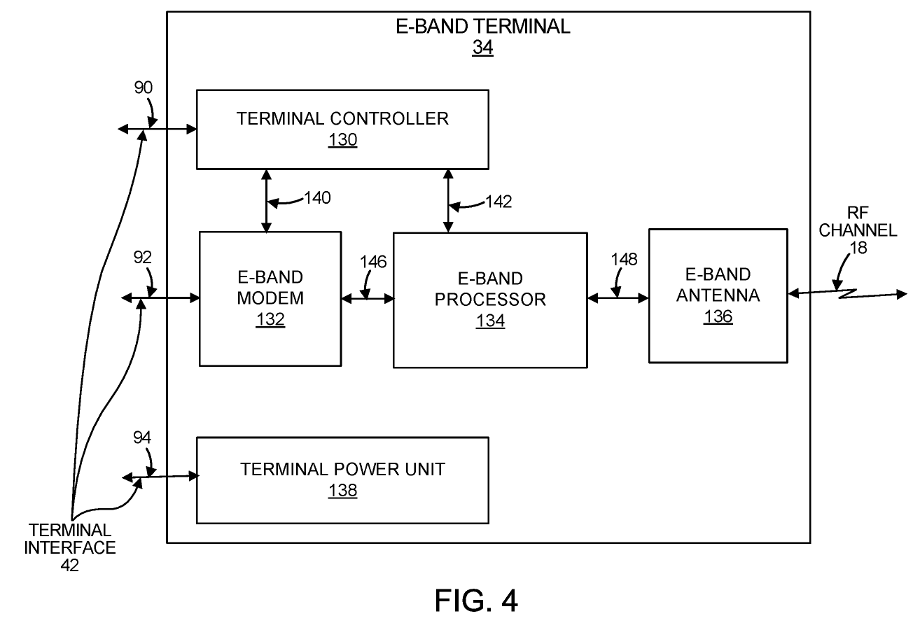

FIG. 4 shows a block diagram of the E-Band terminal 34, according to an embodiment. The E-Band terminal 34 includes a terminal controller 130, an E-Band modulator/demodulator (modem) 132, an E-Band RF processor 134, an E-Band antenna 136, and a terminal power unit 138. The E-Band terminal 34 interfaces with the switch/controller 30 via the terminal interface 42. It transmits a modulated E-Band signal over the RF channel 18 to the remote node 14. It also receives a modulated E-Band signal over the RF channel 18 that was sent from the remote node 14. In alternative configurations, different, and/or additional components may be included in FIG. 4. Furthermore, the components in the block diagram may be deployed in one or more physical devices and embodied in software, firmware, hardware, or any combinations thereof.

The terminal controller 130 is responsible for configuring and monitoring the E-Band terminal. It receives configuration commands from and provides status, performance, and alarm information to the node controller 70 via the management interface 90 portion of the terminal interface 42. The terminal controller 130 delivers configuration commands to and receives status, performance and alarm information from the E-Band modem 132 via a dedicated interface 140. The terminal controller 130 also provides E-Band management data, to be multiplexed into the transmitted data, to the E-Band modem 132 and receives E-Band management data, demultiplexed from the received data, from the E-Band modem 132 over the same dedicated interface 140. The terminal controller 130 delivers configuration commands to and receives status, performance and alarm information from the E-Band RF processor 134 via another dedicated interface 142.

The E-Band modem 132 is responsible for modulating a digital baseband carrier. In some embodiments, the E-Band modem 132 performs data processing functions, including framing, interleaving, and forward error correction (FEC) coding, prior to modulating the digital baseband carrier. Further, in some embodiments, the E-Band modem 132 employs quadrature amplitude modulation (QAM) to modulate digital baseband carrier. Further, in some embodiments, the E-Band modem 132 employs QAM of order ranging from 2 BPSK (one bit per symbol) to 128 QAM (7 bits per symbol). Further, in some embodiments, the E-Band modem performs adaptive coding, modulation and baud (ACMB) techniques to automatically adjust to link degradations due to weather. In some embodiments, the E-Band modem 132 modulates the baseband carrier at a data rate sufficient to transmit at least 10 Gbps of user data plus overhead data including management channel data and FEC overhead. In a second embodiment, the E-Band modem 132 modulates the baseband carrier at a data rate sufficient to transmit between 2.5 Gbps and 5 Gbps of user data plus overhead data including management channel data and FEC overhead. Further in the second embodiment, the E-Band modem 132 employs orthogonal frequency division multiplexing (OFDM) modulation techniques to improve the E-Band links' tolerance to multipath effects.

The modulated digital baseband carrier is delivered to the E-Band RF processor 134 via a digital baseband interface 146.

The E-Band modem 132 is also responsible for equalizing and demodulating the received digital baseband signal provided by the E-Band RF processor 134. The received digital baseband signal is provided by the E-Band RF processor 134 to the E-Band modem 132 via interface 146.

In some embodiments, the E-Band modem 132 performs data processing functions, including de-framing, de-interleaving, and forward error correction (FEC) decoding, after demodulating the digital baseband signal. Further, in some embodiments, the E-Band modem 132 employs quadrature amplitude modulation (QAM) to demodulate the digital baseband signal. Further, in some embodiments, the E-Band modem 132 employs QAM demodulation of order ranging from 2 BPSK (one bit per symbol) to 128 QAM (7 bits per symbol). Further, in some embodiments, the E-Band modem performs adaptive coding, modulation and baud (ACMB) techniques to automatically adjust to link degradations due to weather. In some embodiments, the E-Band modem 132 demodulates the digital baseband signal at a data rate sufficient to receive at least 10 Gbps of user data plus overhead data including management channel data and FEC overhead. In a second embodiment, the E-Band modem 132 demodulates the baseband carrier at a data rate sufficient to receive between 2.5 Gbps and 5 Gbps of user data plus overhead data including management channel data and FEC overhead. Further in the second embodiment, the E-Band modem 132 employs orthogonal frequency division multiplexing (OFDM) demodulation techniques to improve the E-Band links' tolerance to multipath effects.

The E-Band modem 132 accepts data to be transmitted from the switch/controller unit 30 via the data interface of the terminal interface 42. It also accepts E-Band management data from the terminal controller 130 and then multiplexes the management data into the transmit data stream prior to modulation.

The E-Band RF processor 134 up-converts the digital baseband signal provided by the E-Band modem 132 via interface 146, shifting the signal from baseband to a high center frequency and then amplifies the result prior to transmission (E-band transmit signal). The E-Band RF processor also amplifies and down-converts the receive E-Band signal from a high center frequency to baseband (baseband receive signal) prior before passing it to the E-Band modem 132. The E-Band RF processor 134 accepts the baseband transmit signal from the E-Band modem 132 and delivers the baseband receive signal to the E-Band modem 132 via digital baseband interface 146. After amplification, the E-Band transmit signal is sent by the E-Band RF processor 134 through the E-Band antenna 136 toward the remote node 14 via an RF interface 148. Similarly, the E-Band RF processor 134 first accepts the receive E-Band signal from the remote node 14 through the E-Band antenna 136 via the RF interface 148.

In some embodiments, the E-Band RF processor 134 up-converts the baseband transmit signal to a center frequency between 71 GHz and 86 GHz (the E-Band). Further, in some embodiments, the E-Band RF processor 134 down-converts the receive signal from a center frequency between 71 GHz and 86 GHz (the E-Band) to baseband. Further, in some embodiments, either the E-Band RF processor 134 up-converts the baseband transmit signal to center frequency between 71 GHz and 76 GHz and down-converts the receive signal from a center frequency between 81 GHz and 86 GHz, or the E-Band RF processor 134 up-converts the baseband transmit signal to center frequency between 81 GHz and 86 GHz and down-converts the receive signal from a center frequency between 71 GHz and 76 GHz to baseband. The local node 12 and the remote node 14 are configured such that they each receive signals with center frequencies matching that of the other's transmit center frequency.

In some embodiments, transmit and receive frequencies are programmable.

In some embodiments, the E-Band Terminal 34 generates and transmits a single E-Band signal (an E-Band transmit signal) on the vertical polarization. In that embodiment, the E-Band Terminal 34 receives and processes a single E-Band signal (an E-Band receive signal) on the vertical polarization.

In another embodiment, the E-Band Terminal 34 generates and transmits a single E-Band signal (an E-Band transmit signal) on the horizontal polarization. In that embodiment, the E-Band Terminal 34 receives and processes a single E-Band signal (an E-Band receive signal) on the horizontal polarization.

In another embodiment, the E-Band Terminal 34 generates and transmits a single E-Band signal (an E-Band transmit signal) on the clockwise circular polarization. In that embodiment, the E-Band Terminal 34 receives and processes a single E-Band signal (an E-Band receive signal) on the clockwise circular polarization.

In another embodiment, the E-Band Terminal 34 generates and transmits a single E-Band signal (an E-Band transmit signal) on the counter-clockwise circular polarization. In that embodiment, the E-Band Terminal 34 receives and processes a single E-Band signal (an E-Band receive signal) on the counter-clockwise circular polarization.

In another embodiment, the E-Band Terminal 34 generates two independent E-Band transmit signals, as described above, each operating at up to 10 Gbps. The first of the two E-Band transmit signals is transmitted via the antenna on the horizontal polarization while the second of the two E-Band transmit signals is transmitted via the antenna on the vertical polarization. In this embodiment, the E-Band Terminal 34 receives and processes two E-Band receive signals, as described above, each operating at up to 10 Gbps. The first of the two E-Band receive signals is received via the antenna on the horizontal polarization while the second of the two E-Band receive signals is received via the antenna on the vertical polarization.

In another embodiment, the E-Band Terminal 34 generates two independent E-Band transmit signals, as described above, each operating at up to 10 Gbps. The first of the two E-Band transmit signals is transmitted via the antenna on the clockwise circular polarization while the second of the two E-Band transmit signals is transmitted via the antenna on the counter-clockwise circular polarization. In this embodiment, the E-Band Terminal 34 receives and processes two E-Band receive signals, as described above, each operating at up to 10 Gbps. The first of the two E-Band receive signals is received via the antenna on the clockwise circular polarization while the second of the two E-Band receive signals is received via the antenna on the counter-clockwise circular polarization.

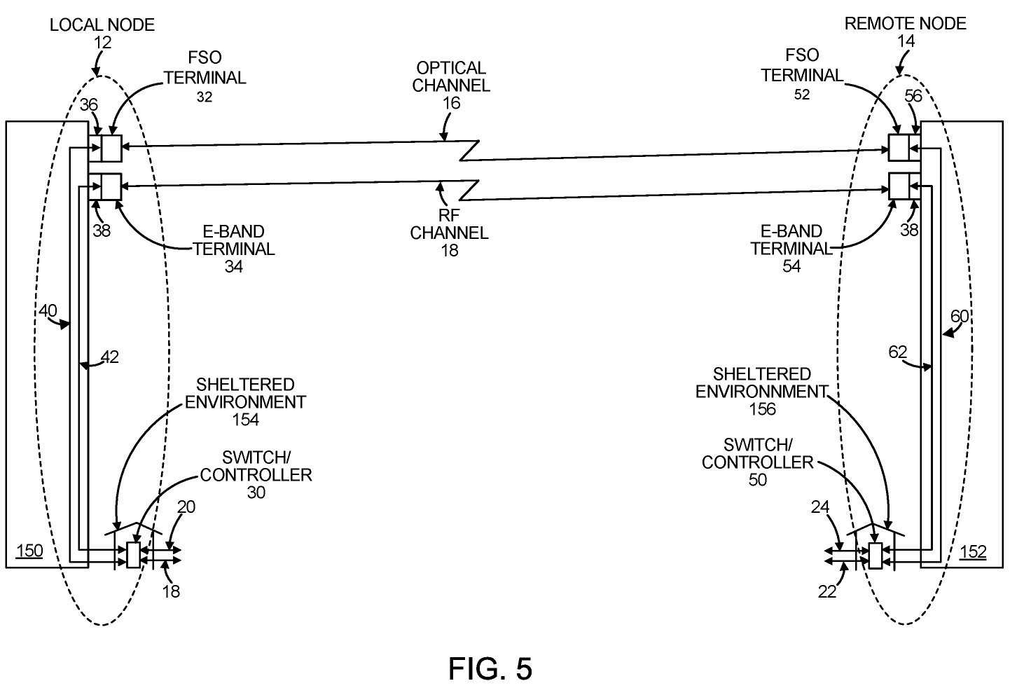

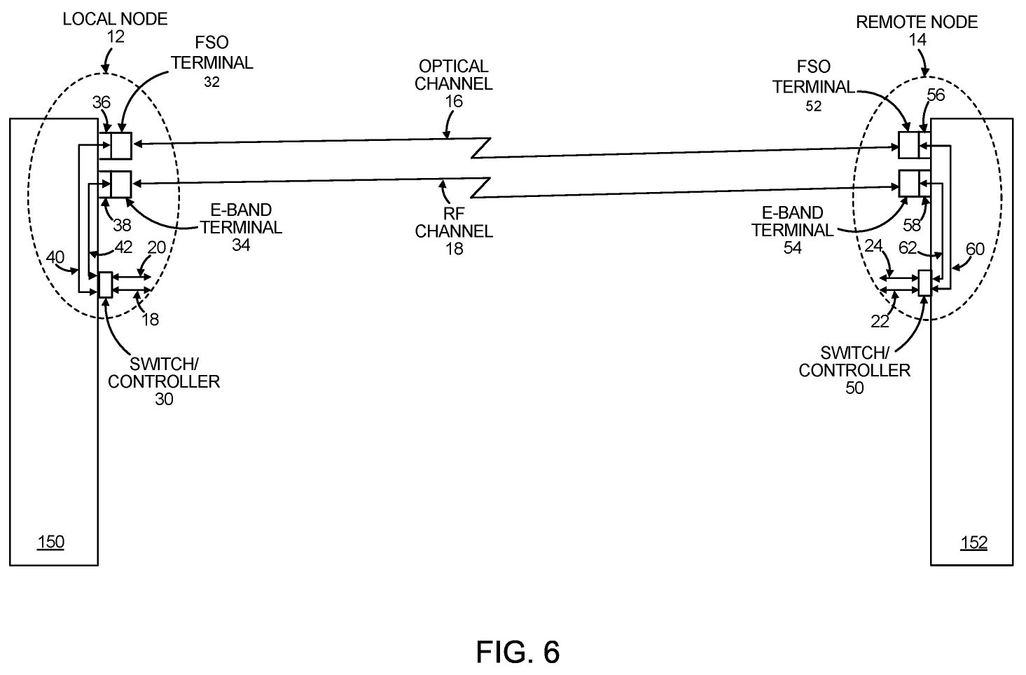

FIG. 5 is a block diagram of the local node 12 and the remote node 14, in which the switch/controller units 30 and 50 are installed in sheltered locations 154 and 156 and the FSO terminals 32 and 53 and the E-Band terminals 34 and 54 are mounted on external structures 150 and 152, according to an embodiment. FIG. 6 is a block diagram similar to FIG. 5 except that the switch/controller units 30 and 50 are installed on the external structures 150 and 152, according to an embodiment. In alternative configurations, different, and/or additional components may be included in FIGS. 5 and 6.

The switch/controller 30 is a stand-alone integrated subsystem. In some embodiments, the switch/controller is a rack-mountable device that can be installed in a telecommunications equipment rack in a sheltered environment 154, such as an equipment room, equipment cabinet, or equipment hut, in or near the structure 150 on which the terminals are installed, as shown in FIG. 5. In another embodiment, the switch/controller 12 is enclosed in a weather-proof enclosure and mounted on the structure 150 near the two terminals, as shown in FIG. 6.

The FSO terminal 32 and the E-Band terminal 34 are each a stand-alone integrated subsystem. Each is enclosed in a weather-proof enclosure and mounted, using terminal mounts 36 and 38, on a structure 150 with a clear line-of sight to the remote node 14 installed on the remote structure 152. The structures 150 and 152 may be buildings, telecommunication towers, or other structures suitable for such use. The remote structure 152 may be of the same type as or may differ from the local structure 150.

In some embodiments, the FSO terminal 32 and the E-Band terminal 34 are co-located to each other. For example, the terminals may be up to 10 feet apart from each other. Furthermore, while the FSO terminal 32 and the E-Band terminal 34 are mounted to the same structure 150 in FIGS. 5 and 6, the terminals may be mounted to separate structures.

The terminal mounts 36 and 38 provide azimuth and elevation adjustment to allow each terminal to be accurately pointed at the remote node 14 during installation. In some embodiments, the terminal mount 36 used for the FSO terminal 32 is identical to the terminal mount 38 used for the E-Band terminal 34. In an alternate embodiment, the terminal mount 38 used for the E-Band terminal 34 includes an active, automatic pointing and tracking system to maintain accurate pointing at the remote node 14.

While embodiments described with reference to FIGS. 1-5 only include the local node 12 and a remote node 14, the nodes may be integrated into a network of nodes. For example, the remote node 14 may be coupled to a third node that receives data from the remote node 14 and transmits the data to a fourth node. For example, the management interface 24 and the network interface 22 of the remote node 14 are connected to a switch controller of the third node. Alternatively, the remote node 14 and the third node are integrated together such that the switch controller 50 is a switch controller for the remote node 14 and the third node. In these embodiments the switch controller 50 may be coupled to another FSO terminal and E-Band terminal that are directed towards the fourth node.

What is claimed is:

1. A local node that provides a hybrid wireless link to a remote node, the local node comprising:
a free space optical (FSO) terminal configured to transmit data to the remote node over a free space optical link;
a radio frequency (RF) terminal configured to transmit data to the remote node over a free space RF link, wherein the free space optical link and the free space RF link together form the hybrid wireless link between the local node and the remote node; and
a switch/controller coupled to the FSO terminal and to the RF terminal, the switch/controller configured to receive data, to determine at the data link layer whether to transmit data frames of the data over the free space optical link and/or over the free space RF link wherein the determination is based on a content of the data frames, and to steer the data frames to the FSO terminal and/or to the RF terminal based on the determination.

2. The local node of claim 1, wherein the switch/controller implements a data link protocol for hybrid wireless links.

3. The local node of claim 1, wherein the switch/controller determines at the data link layer whether to transmit data frames over the free space optical link and/or over the free space RF link based on at least one of: ingress port, egress port, MAC source address, MAC destination address, EtherType, outer 802.1Q tag VLAN ID, outer 802.1Q tag PCP, outer 802.1Q tag DEI, inner 802.1Q tag VLAN ID, inner 802.1Q tag PCP, inner 802.1Q tag DEI, IPv4 source address, IPv4 destination address, IPv4 DSCP, IPv4 ECN, IPv4 protocol field, IPv6 source address, IPv6 destination address, IPv6 traffic class, IPv6 Next Header, IPv6 flow label, IPv6 SRH, outer MPLS tag label, outer MPLS tag EXP (QoS or ECN), one or more inner MPLS tag labels, or one or more inner MPLS tags EXP (QoS or ECN).

4. The local node of claim 1, wherein the switch/controller determines at the data link layer whether to transmit data frames over the free space optical link and/or over the free space RF link based on a condition of the hybrid wireless link, the condition of the hybrid wireless link including at least one of: instantaneous or time averaged throughput; frame loss ratio; latency; jitter; link utilization; expected or calculated link availability; link state (link up or down); predicted link performance based on link location, time of day, time of year; or measured, reported, or estimated atmospheric conditions.

5. The local node of claim 1, wherein the switch/controller is configured to steer individual data frames alternately to the free space optical link and to the free space RF link.

6. The local node of claim 1, wherein the switch/controller comprises:
a switching component configured to receive the data frames and perform data link layer functions on the data frames; and
a data link protocol component configured to receive the data frames from the switching component and steer the data frames to the FSO terminal and/or to the RF terminal.

7. The local node of claim 6, wherein none of the data link layer functions performed by the switching component are specific to hybrid wireless links.

8. The local node of claim 6, wherein the switching component determines a class of service and/or a quality of service for data frames based on the content of the data frames, and whether to transmit the data frames over the free space optical link and/or over the free space RF link is based on the class of service and/or the quality of service.

9. The local node of claim 6, wherein the switching component determines a traffic treatment for data frames based on the content of the data frames, and whether to transmit the data frames over the free space optical link and/or over the free space RF link is based on the traffic treatment.

10. The local node of claim 6, wherein the switch/controller implements a data link protocol for hybrid wireless links, and the data link protocol component implements an entirety of the data link protocol.

11. The local node of claim 10, wherein the data link protocol implements a plurality of traffic treatments assigned to the data frames, and the data link protocol component steers the data frames to the FSO terminal and/or to the RF terminal based on the traffic treatment assigned to the data frame.

12. The local node of claim 11, wherein traffic treatments are assigned to data frames based on at least one of VLAN tag, port number, and traffic type.

13. The local node of claim 6, wherein the switching component produces tags for the data frames based on their content, and the data link protocol component steers the data frames to the FSO terminal and/or to the RF terminal based on a lookup table that maps the tags to the FSO terminal and/or the RF terminal.

14. The local node of claim 6, wherein the data link protocol component manages retransmission of data frames in an event of lost data.

15. The local node of claim 1, wherein the hybrid wireless link is bidirectional.

16. The local node of claim 15, wherein the local node and the remote node are part of a network with additional other nodes.

17. The local node of claim 1, wherein the free space optical link has a nominal data rate of at least 10 Gbps and the local node and the remote node are located at least 4 km apart.

18. The local node of claim 1, wherein the free space optical link operates in an infrared wavelength range and the free space RF link operates in an E-band.

19. A local node that provides a hybrid wireless link to a remote node, the local node comprising:
a physical layer comprising:
a free space optical (FSO) terminal configured to transmit data to a remote node over a free space optical link; and
a radio frequency (RF) terminal configured to transmit data to the remote node over a free space RF link, wherein the free space optical link and the free space RF link together form a hybrid wireless link between the local node and the remote node; and
a data link layer that determines whether data frames of the data are transmitted to the remote node over the free space optical link and/or over the free space RF link.

20. A local node that provides a hybrid wireless link to a remote node, the local node comprising:
a free space optical (FSO) terminal configured to transmit data to a remote node over a free space optical link;
a radio frequency (RF) terminal configured to transmit data to the remote node over a free space RF link, wherein the free space optical link and the free space RF link together form a hybrid wireless link between the local node and the remote node; and
a controller coupled to the FSO terminal and to the RF terminal, the controller configured to receive data, to determine at the data link layer and/or the network layer whether to transmit data frames and/or network packets of the data over the free space optical link and/or over the free space RF link wherein the determination is based on a content of the data frames and/or network packets, and to steer the data frames and/or network packets to the FSO terminal and/or to the RF terminal based on the determination.
